(19) United States
(12) Patent Application Publication
(10) Pub. No.: US 2009/0133585 A1
(43) Pub. Date: May 28, 2009

(54) REMAINING POPPING OIL GAUGE AND METHODS

(75) Inventors: TIMOTHY A. RHOME, Milford, OH (US); John Ryan, Independence, KY (US)

Correspondence Address: WOOD, HERRON & EVANS, LLP, 2700 CAREW TOWER, 441 VINE STREET, CINCINNATI, OH, 45202, US

(73) Assignee: GOLD MEDAL PRODUCTS CO., Cincinnati, OH (US)

(21) Appl. No.: 12/323,920

(22) Filed: Nov. 26, 2008

Related U.S. Application Data
(60) Provisional application No. 60/990,343, filed on Nov. 27, 2007.

(51) Int. Cl. A23L 1/18; G01F 23/20; G08B 21/00

(52) U.S. Cl. 99/323.7; 73/296; 340/613

(57) ABSTRACT

Oil remaining for use in popcorn popping is continuously weighed and a signal indicating the status of remaining oil is generated to warn when oil must be replenished. Apparatus and methods are disclosed.

### PRIORITY CLAIM

Applicant claims the benefit of the filing date of Nov. 27, 2007 of U.S. provisional patent application Ser. No. 60/990,343, which application is expressly incorporated herein by reference.

### BACKGROUND OF THE INVENTION

This invention relates to popping of popcorn and more particularly to gauging the amount of oil remaining for use in popcorn popping operation.

Popcorn is frequently provided in large quantities in commercial operations such as movie theaters and in other applications. The quality and appetizing appeal of the popcorn is important to operators of such theaters and other venues. Fresh, properly cooked, unburned corn, together with fresh popcorn aroma is desired.

When popcorn is popped in kettles in such venues, it is common to add both oil and unpopped kernels to a kettle, which heats the oil and pops the corn. While many parameters can affect the proper popping and quality of popped corn, having sufficient oil for the popping cycle is important. In many applications and poppers, the oil is stored in the popping apparatus and is automatically provided to the popping kettle for each batch of popcorn to be popped.

A significant problem for venues such as theaters is that the operators of the popping operation do not know or do not notice that the liquid oil storage is low or empty until they “run out”. Oil is typically stored in Bag-in-Box containers or reservoirs behind closed doors of the large popper cabinets. Unfortunately, the result is that a low charge of oil is introduced into the kettle and the popcorn will burn. That, of course, results in lost popcorn in the storage bin, but perhaps more importantly is the unappealing odor of burned popcorn into the theater.

Accordingly, it is one objective of the invention to eliminate the problems associated with insufficient oil for a popcorn popping cycle.

It is another objective of the invention to provide a warning to an operator of an impending low supply of popping oil so the appropriate oil reservoir can be replenished or replaced.

A further objective of the invention has been to provide improved apparatus for sensing and warning of insufficient remaining oil in a popcorn machine.

A yet further objective of the invention has been to provide improved methods for sensing low or remaining oil supply in a popcorn machine and for providing a warning of that condition.

### SUMMARY OF THE INVENTION

To these ends, one embodiment of the invention contemplates the supply of oil in a popcorn machine via a bag-in-box replacement supply where the oil is contained in a bag provided in a box, both replaceable when remaining oil is low. One or more bag-in-box reservoirs are replaceably disposed in a bag-in-box oil dispenser comprising a rack receiving and supporting the bag-in-box. A load cell is operably associated with the rack for sensing weight changes due to oil uses and signaling the declining volume of remaining oil, and for signaling when the usable remaining oil weight falls below a predetermined amount.

In this way, an operator can keep track of remaining useful oil in the system and/or be warned when remaining oil quantity is low, so that the oil supply can be replenished and popping with insufficient oil charge in the kettle is eliminated. Alternately, the signaling apparatus could be calibrated to indicate the amount of oil used, rather than that remaining.

With more particularity, the invention contemplates signaling a declining volume of popping oil, as oil is used, as a function of the weight of the remaining oil available for use. In other words, as the oil is used, the weight of oil used also diminishes, leaving only remaining oil and its weight. One embodiment of the invention contemplates use of a load cell having an output responsive to current weight of the oil. The load cell output is connected to a warning apparatus, such as a visual or auditory signaling device, to indicate to the user the status of oil remaining for use. When the supply of remaining oil is low, one or more oil reservoirs, such as an oil containing bag or box, is replaced with a fresh or full supply, and the apparatus recalibrated.

Structurally, one or more oil reservoirs are placed in a rack which is disposed preferably in a popper cabinet. One end of the rack is supported on the cabinet floor, while the other end is supported on a load cell having one side disposed on the cabinet floor or other cabinet structure. The load cell produces a signal in response to the portion of the weight of the oil supply rack it senses and that signal is operably connected to an apparatus for signaling the amount of remaining oil in the rack-supported reservoir.

Other structural and method features will become more apparent from the following description, and from the drawings in which:

### BRIEF DESCRIPTION OF THE DRAWINGS

FIG. 1 is an isometric illustration of an illustrative popcorn popper according to the invention;

FIG. 2 is a perspective illustration of a popper cabinet and oil supply rack according to the invention;

FIG. 3 is a perspective illustration of an oil supply rack of FIG. 2, removed from the popper apparatus for clarity;

FIG. 4 is a perspective view of the rear of the rack of FIGS. 2 and 3;

FIG. 5 is an illustrative perspective view of the rear underside of an oil supply rack according to the invention;

FIG. 6 is a circuit diagram illustrating electrical components of the invention; and

FIG. 7 is a flow chart illustrating operation of the invention.

### DETAILED DESCRIPTION OF A PREFERRED EMBODIMENT

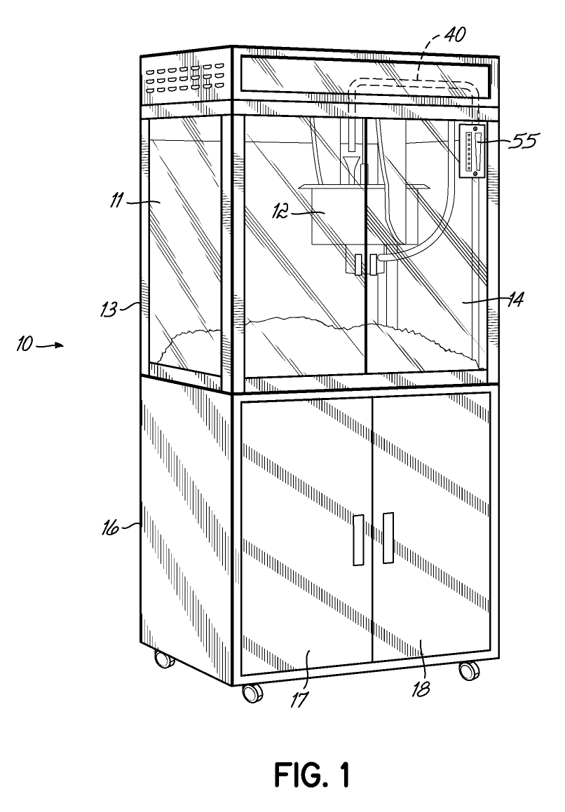

Turning now to FIG. 1, there is illustrated a large volume popcorn popper 10 of the type useful for industrial or institution application. Popper 10 includes a popper chamber 11 with at least one popping kettle 12 therein. Popping chamber 11 is defined by an upper cabinet 13 having one or more typically transparent doors 14. A control panel is mounted in cabinet 13. These components are shown for background and environmental purposes in which the invention is used.

Whether or not part of the control panel, a signal panel 55 according to the invention is also preferably mounted thereon or in proximity thereto, although it could be mounted in a convenient position elsewhere.

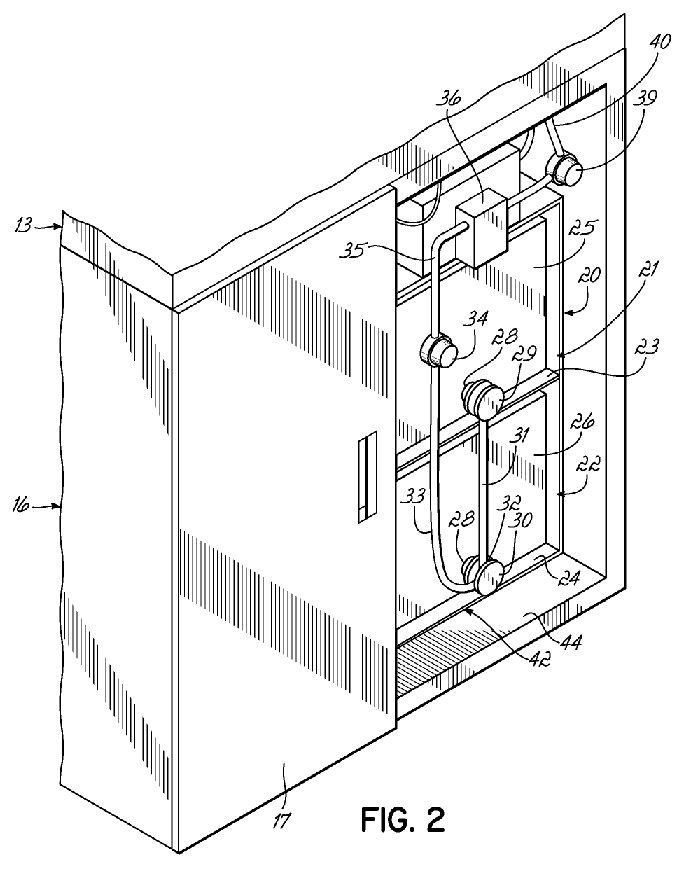

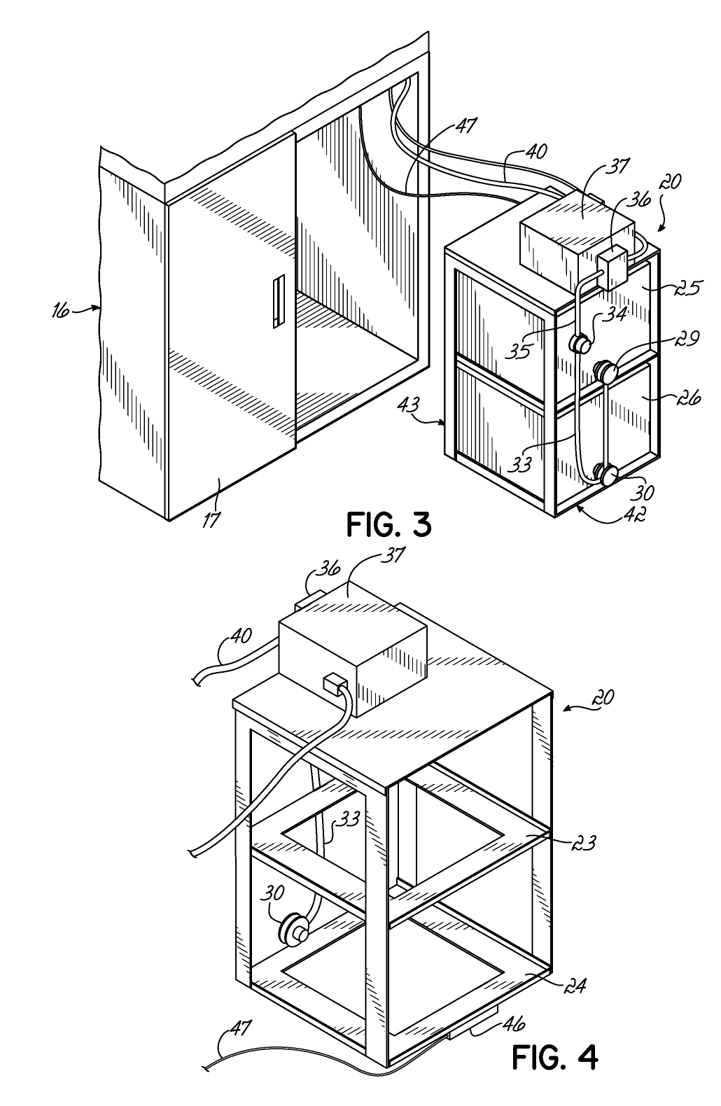

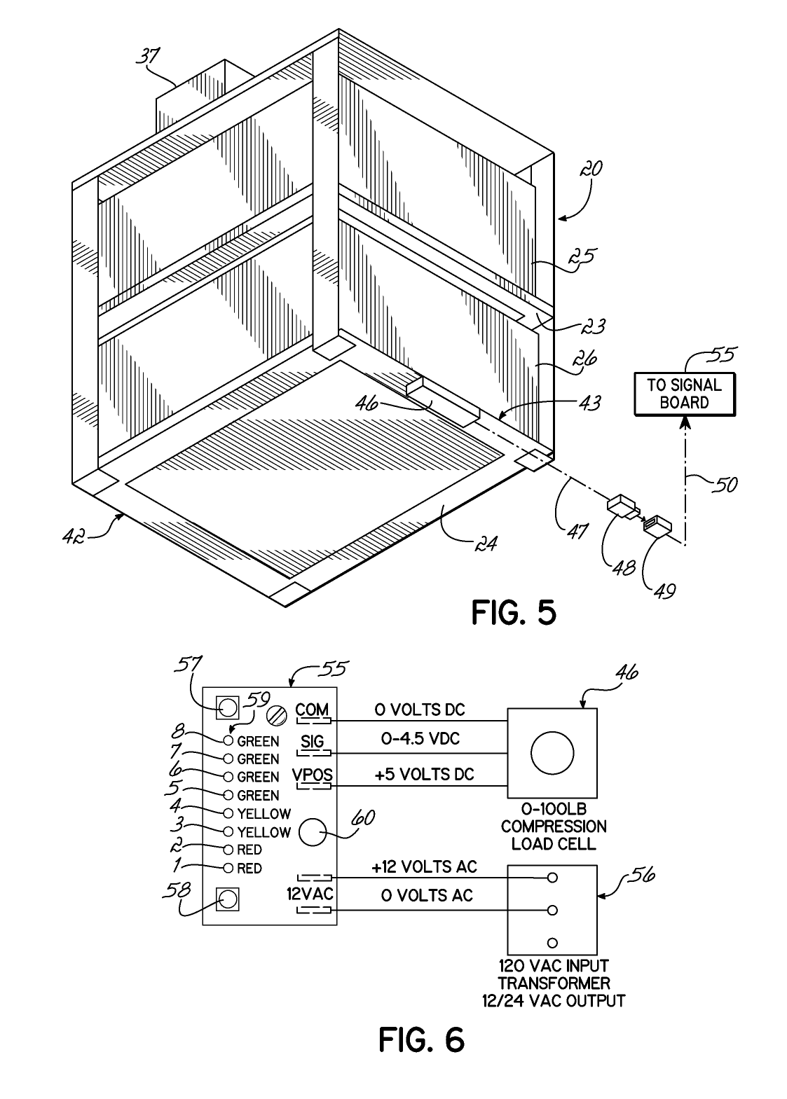

Beneath upper cabinet 13 is a lower cabinet 16 having doors 17, 18. An oil reservoir supporting member or rack 20 is disposed within lower cabinet 16 as best seen in FIG. 2. Rack 20 may also be referred to as an oil dispenser. In this embodiment, rack 20 has first and second upper and lower compartments 21, 22, each with a shelf 23, 24, which are for supporting upper and lower oil reservoirs 25, 26 (see FIG. 5). Oil reservoirs 25, 26 comprise oil containing bags mounted in boxes as illustrated and as well known.

Each reservoir 25, 26 includes an outlet or spigot 28 which is operably cooperative with a fitting 29, 30 for dispensing oil from the reservoir.

Preferably, fitting 29 has an outlet connected by hose 31 to fitting 30, such that oil from reservoir 25 drains by gravity to an inlet 32 of fitting 30, which is connected to a spigot 28 of lower reservoir 26. Fitting 30 is connected by hose 33, through filter 34 and hose 35 to a pump 36 located in association with housing 37. Pump 36 may be any suitable form of oil pump, such as a diaphragm or solenoid pump.

From pump 36, oil is pumped through another filter 39 and hose 40 toward the popping kettle for preferably automatic discharge therein. Filter 39 smoothes out or dampens the impulses in the oil from pump 36 to facilitate appropriate discharge into the popping kettle without undue surges or spurts disrupting the desired oil discharge.

Returning momentarily to housing 37 atop rack 20, a fan and a heater (not shown) is disposed in the housing. Fan operation draws air into housing 37 through louvers, the air is warmed, and warm air circulated by the fan downwardly over and around reservoirs 25, 26 and the oil hoses to keep the oil sufficiently liquid and from congealing.

Rack 20 has a front end 42 and a rear end 43. Front end 42 rests on cabinet shelf 44 (FIG. 2) when rack 2 is in place in lower cabinet 16.

A weigh scale such as a load cell 46 shown only diagrammatically herein, is mounted to shelf member 24 of rack 20 at rear end 43 (FIG. 4). The cell 46 extends beneath shelf 24 and rack 20 effectively, such that it rests on cabinet shelf 44 or some other cabinet structure in a manner such that the weight of rack 20 at its secure end is supported by load cell 46. In other words, the load cell 46 is operatively disposed between rack 20 and lower cabinet 16 to bear at least a portion of the weight of rack 20 and any oil reservoirs therein. References herein to weighing the rack 20 or the oil supporting rack include weighing a significant portion of the rack 20 to indicate oil usage.

Load cell 46 has a multiple conductor cable 47 extending to a plug component 48. Plug 48 is operatively connectable to plug component 49, connected through cable 50 to the signal board 55 which is described below. The position of these rack and load cell components are also seen in FIG. 5.

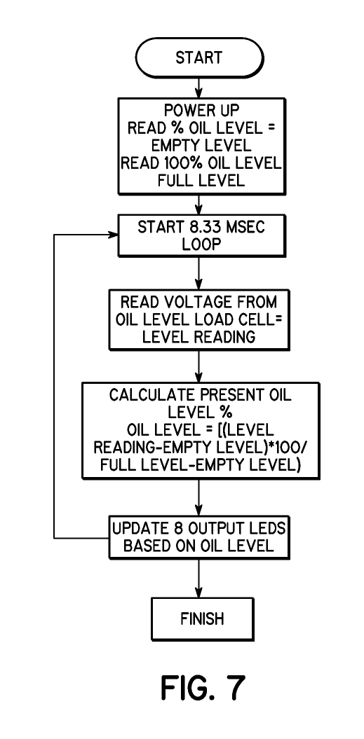

FIGS. 6 and 7 illustrate the operation of remaining oil rack and signaling structure.

Load cell 46 may be any suitable load cell, however, one such cell useful in the in is the load cell manufactured by Measurement Specialties Incorporated of Hampton, Va. This cell is marketed by Digi-Key Corporation of Thief River Falls, Minn., under Model No. FC2231. Cell 46 has a multiple voltage output in response to weights sensed by the load cell. Such multiple outputs are transmitted over cable 50 and are indicated in FIG. 6 extending from cell 46 to signal board 55. Cell 46 is selected to sense loads varying from the sensed empty weight of rack 20 to the sensed weight of rack 20 when filled with full oil reservoirs, and at the rear end 43 of rack 20. The voltage output range of cell 46 is from about zero voltage to about 4.5 volts across this weight range.

A transformer 56 is electrically connected to power cell 46 and board 55 as shown in FIG. 6. Any suitable transformer can be used, however, one suitable transformer is a 120 VAC input transformer having 12/24VAC output and manufactured by the Foster Transformer Company of Cincinnati, Ohio.

Signal board 55 includes calibrating buttons 57 (full) and 58 (empty), and an LED panel 59 having a plurality of LEDs 1-8, preferably of various colors as shown in FIG. 6. Lower LEDs 1 and 2 are red, next upper LEDs 3 and 4 are yellow, and uppermost LEDs 5-8 are green. From this, it will be appreciated that cell 46 outputs to board 55 a variable voltage signal of from 0 volts to about 4.5 volts over line or cable 50, with the amplitude of voltage representing load sensed by load cell 46. These various voltages are connected through board 55 to cause the respective LEDs to light up, in response to and indicating the remaining oil left for usage in rack 20.

The display or warning system may be of any suitable expedient, including a volt meter calibrated or scaled to any suitable scale, a series of signal lights such as LEDs or other suitable visual or audible display devices as will be readily appreciated. FIG. 6 shows an alternate audio device or buzzer 60 of any suitable type in this regard and connected to activate, for example, at the same situation as LED 1 would flash if it were used.

Accordingly, weight changes of the dispenser 12 are indicative of the usage of oil from containers 24, 26. Depletion of oil, and related weight of depleted oil, is sensed by the load cell which generates signals. Such signals can be calibrated to a scale between the full weight and low weight of remaining oil in the system, showing essentially the remaining useful oil left (much in the way remaining fuel is shown by the gas gauge in an automobile). Alternately, the change in sensed weight could be calibrated to a scale representing oil used rather than oil remaining and a signaling device displaying that information, used.

Depending on the nature of the display or warning device used, the amount of remaining oil can be observed at the control panel of popper 10, or elsewhere as desired. Alternately, or in combination therewith, a visual or audible warning or combination thereof can be provided to signal the operator when the supply of oil is nearing change, is low or must be changed. The operator then replaces one or more depleted or nearly depleted containers 24, 26 with new full containers.

Further, the sensing or display apparatus could be operably connected to the control of popping machine 10 to prevent a popping cycle when the remaining oil supply was too low or empty, thereby preventing burned popcorn or burning popcorn aroma from a cycle where there was insufficient oil to properly support the popping cycle.

Operation of the signaling apparatus on filling and starting a new cycle with full oil reservoirs is as follows.

Power is turned on. After a 30 second wait, and with no oil boxes in rack 20, button 58 is pressed and released to set the empty or “tare” sensed weight of rack 20. The rack is then loaded with full oil boxes. After a 30 second weight, button 57 is pressed to set the full sensed weight of rack 20. This calibrates the signal board 20 to the range of oil available and all LEDs are lit. As oil is depleted, weight of rack 20 and the reservoir diminishes. As weight diminishes, load cell senses the changes. Responsive voltage changes preferably indicate less remaining oil (oil reduction is the only weight change) and as weight diminishes, the LEDs are successively de-energized, until only the last red LED is lid, indicating that oil reservoirs are close to empty and need replacement. That last red LED may also be flashed after the yellow LEDs are de-energized to gain operator attention.

In more operative detail, upon power up, the firmware of board 55 will initialize inputs (digital or analog) and outputs, calibrate the internal oscillator, clear all outputs and set the internal clock for a loop cycle time of 8.333 msec.

Upon power up, the firmware will read from an internal EEPROM memory the values corresponding to 0% oil level (Empty Level) and 100% oil level (Full Level). These values can be changed and stored by the user during operation. If no values have been stored (initial power up), the firmware will substitute an approximate level of 0.5V for the 0% level and 4.5V for the 100% level. Each of the stored values are saved in four memory locations and a read routine looks for two identical values (this will increase reliability and make operation possible even if two memory cells were to fail).

After initialization and memory read, the firmware operates by executing an 8.333 msec loop. The loop time was chosen to allow for 60 Hz noise cancellation on analog inputs.

The first task of the loop is to read the voltage from the oil level load cell. The value (Level Reading) used for calculations by the firmware is an average of four load cell readings (this provides for some noise suppression). The present oil level percentage (Oil Level) is calculated from the following equation: Oil Level=[(Level Reading−Empty Level)*100]/(Full Level−Empty Level).

The firmware contains an error manager which will flash all eight level indicating LEDs in response to one of two errors. The first error is detected if the user programmed the Empty Level as a larger load cell voltage than the Full Level. The second error is detected if the Full Level reading is not at least approximately 0.2V greater than the Empty Level.

The status of the eight LEDs used by the oil level sensor is managed by the firmware based on the percentage of oil level calculated. Essentially, once the unit is calibrated with a full load of oil, all LEDs 1-8 are on. The LED in the sequence of 8 down to 2 are turned off as the oil is depleted (i.e. as the declining weight is sensed and signaled to board 55). LED 8 is turned off at 89% full. LED 7 is turned off at 76% full. LED 6 is turned off at 63% full. LED 5 is turned off at 50% full. LED 4 is turned off at 38% full. LED 3 is turned off at 26% full. LED 2 is turned off at 14% full. LED 1 remains on but begins flashing at 5% full. A 2% hysteresis is applied and used to guard against an unstable display with LED 1. LED 1 is never totally turned off. Thus, when the calculated level is below 5%, the LED 1 is flashed. This will ensure that there is always at least one LED visible and provide an alert to the user that the remaining oil level is very low.

The firmware manages two switches which are used to change/store the Full Level and the Empty Level. Pushing either of these switches will store in EEPROM memory the present value from the load cell as either the Full Level or the Empty Level (depending on which switch was used). The value is stored in four memory locations. The value is also updated within the loop for instantaneous use. Activation of either switch is indicated through flashing LEDs 4 and 5 on the oil level display.

FIG. 7 illustrates, in a self-explanatory flow chart, this operation.

It will be appreciated that while an embodiment utilizing two reservoirs 25, 26 is disclosed, the invention in other embodiments can be easily used in systems with only one, or more than two reservoirs, as described. It could also be adapted for use where the reservoir is permanent and is refilled by pouring oil therein, with similar pre-filled and after-filled calibrations.

It will also be appreciated that the signal produced by the load cell is indicative of the amount of oil used in a popping operation, where that indicator is useful. Accordingly, the signaling apparatus can be set up and calibrated to indicate oil used, rather than oil remaining.

It will also be appreciated that while the rack 20 or oil supporting member is described as a rack, it may be defined by a variety of structures, frames or other oil supporting devices. Also, it is not necessary that the rack 20 have its bottom resting on the floor of the enclosing cabinet 16. Alternately, the rack 20 can be supported by any suitable apparatus, including hangers, brackets or the like. Likewise, the rack 20 may have other structures than the bottom rear shelf as shown, for resting on the load cell 46. Any suitable supporting structure for the rack can be used, creating an environment where changes in the weight of remaining oil can be sensed by a weigh scale such as load cell 46.

Also, it will be appreciated that while the described embodiment shows forward and rearward ends of rack 20 supported in the cabinet floor and on the load cell, one side of rack 20 could be supported on the cabinet and the opposite side on the load cell.

These and other advantages, embodiments and modifications will be readily apparent from the foregoing to those of ordinary skill in the art without departing from the scope of the invention and applicant intends to be bound only by the claims appended hereto.

What is claimed is:

1) apparatus for monitoring remaining oil in an oil supply comprising:
an oil supporting member;
a weigh scale for weighing said oil supporting member;
an indicator operatively connected to the weigh scale for indicating weight changes of the dispenser.

2) Apparatus for indicating the amount of remaining oil in a popcorn popper and indicating when the amount of remaining oil reaches a predetermined amount, said apparatus comprising:
an oil dispenser;
a load cell connected to said dispenser, said load cell capable of producing a signal responsive to weight changes of said dispenser;
an indicator operatively connected to said load cell and displaying the status of the weight of the dispenser.

3) Apparatus as in claim 2 wherein said indicator displays the status of said weight throughout depletion of oil in said dispenser.

4) Apparatus as in claim 3 wherein said display comprises at least visual alarm.

5) Apparatus as in claim 2 wherein said load cell supports about one-half the weight of said dispenser.

6) Apparatus as in claim 5 wherein said one portion of said dispenser is supported by said popcorn popper and another portion by said load cell.

7) A popcorn popper having a kettle, a popping chamber and apparatus for delivering oil to said kettle, said popper further including:
an oil reservoir holding oil for use in said kettle;
a weigh scale for sensing the weight of said reservoir and initiating a signal responsive to said weight as said oil is used;
a signal apparatus operatively connected to said weigh scale and indicating changes in the weight of said reservoir as oil is used in popping popcorn.

8) A popper as in claim 7 wherein said signal apparatus includes a visual signal responsive to weight changes in said reservoir.

9) A popper as in claim 7 including a rack supporting at least one oil reservoir, said rack supported at one end by said popper and at another end by said weigh scale.

10) A popper as in claim 9 wherein said weigh scale is a load cell having a variable voltage output responsive to sensed weight changes of oil in said reservoir.

11) A popper as in claim 7 wherein said popper includes a cabinet and a rack for supporting said oil reservoir, wherein said rack is removable from said cabinet.

12) A popper as in claim 7 including an oil pump operatively connected to said oil reservoir and a conduit operatively connected to transfer oil pumped from said reservoir to said kettle.

13) A popper as in claim 12 further including:
a first conduit operatively connected from said reservoir to said pump;
a second conduit operatively connected from said pump to said kettle; and
further including an oil filter in each conduit.

14. Popcorn popping apparatus comprising:
a popping kettle for popping popcorn;
a cabinet oriented below said kettle and defining a popping oil storage compartment;
at least one oil reservoir supporting member in said compartment;
a weigh scale;
said supporting member having one portion for resting on said cabinet and another portion resting on said weigh scale;
whereby said weigh scale is operably disposed for sensing changes in the weight of said member as oil is used to pop popcorn in said kettle.

15. Apparatus as in claim 14 wherein said oil supporting member comprises a rack having forward and rearward ends and opposed sides, one of said ends and sides resting on said cabinet and another of said ends or sides operatively disposed on said weigh scale.

16) A method of warning of the depletion of oil in a popcorn popper comprising the steps of:
weighing the oil in a popper;
sensing the use of oil by sensing the depletion of weight of said oil; and
initiating a signal indicative of the amount of oil at least one of remaining or used.

17) A method as in claim 16 including initiating said signal indicative of a predetermined amount of useful oil remaining in the popper.

18) A method as in claim 16 including initiating a signal indicative of the amount of oil used in a popping apparatus.

19. A method as in claim 16 including initiating an audio signal warning of one of low oil level remaining or significant oil used.
